(19) United States
(12) Patent Application Publication
(10) Pub. No.: US 2016/0251968 A1
(43) Pub. Date: Sep. 1, 2016

(54) GAS TURBINE ENGINE AIRFOIL COOLING CONFIGURATION WITH PRESSURE GRADIENT SEPARATORS

(71) Applicant: United Technologies Corporation, Hartford, CT (US)

(72) Inventors: San Quach, East Hartford, CT (US); Ryan Alan Waite, South Windsor, CT (US); Christopher King, Bristol, CT (US); Steven Bruce Gautschi, Naugatuck, CT (US)

(21) Appl. No.: 14/632,485

(22) Filed: Feb. 26, 2015

(51) Int. Cl. F01D 5/18; F23R 3/00; F01D 11/08; F01D 25/30; F01D 5/14; F01D 9/04

(52) U.S. Cl. CPC F01D 5/187; F01D 5/147; F01D 9/041; F01D 11/08; F01D 25/30; F23R 3/002; F05D 2220/32; F05D 2240/122; F05D 2240/304; F05D 2240/35; F05D 2240/55; F05D 2260/221

(57) ABSTRACT

An airfoil for a gas turbine engine includes an airfoil including spaced apart pressure and suction side walls joined at leading and trailing edges to provide an exterior airfoil surface that extends in a radial direction from a platform to a tip. A cavity is provided between the pressure and suction side walls near the trailing edge. The cavity includes an interior region bounded by first and second exit regions arranged at angle relative to one another. The first and second exit regions are respectively in low and high pressure regions relative to one another. First and second pedestal groups respectively are arranged at the first and second exit regions. The second pedestal group has first and second pedestals each terminating in an end. The ends of the second pedestals extend beyond the ends of first pedestals.

### STATEMENT REGARDING FEDERALLY SPONSORED RESEARCH OR DEVELOPMENT

This invention was made with government support under Contract No. N68335-13-C-0005 awarded by the United States Navy. The Government has certain rights in this invention.

### BACKGROUND

This disclosure relates to a gas turbine engine component, such as an airfoil. More particularly, the disclosure relates to a cooling configuration used to effectively turn the cooling fluid at two adjacent cooling fluid exits.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

Many blades and vanes, blade outer air seals, turbine platforms, and other components include internal cooling passages. Blade trailing edge tips are typically susceptible to high temperature damage such as thermal mechanical fatigue, and/or oxidation. Current airfoil designs tend to leave the trailing edge tip without convective cooling.

To address this concern, one example airfoil design adds flow features at the tip, which enables the entire trailing edge to be convectively cooled. Discrete slots or a large continuous slot is provided the length of the trailing edge all the way to the tip.

### SUMMARY

In one exemplary embodiment, an airfoil for a gas turbine engine includes an airfoil including spaced apart pressure and suction side walls joined at leading and trailing edges to provide an exterior airfoil surface that extends in a radial direction from a platform to a tip. A cavity is provided between the pressure and suction side walls near the trailing edge. The cavity includes an interior region bounded by first and second exit regions arranged at angle relative to one another. The first and second exit regions are respectively in low and high pressure regions relative to one another. First and second pedestal groups respectively are arranged at the first and second exit regions. The second pedestal group has first and second pedestals each terminating in an end. The ends of the second pedestals extend beyond the ends of first pedestals.

In a further embodiment of the above, the airfoil is a blade.

In a further embodiment of any of the above, the airfoil extends from the leading edge to the trailing edge in a chord-wise direction. The cavity is provided in at least the last 20% of the airfoil near the trailing edge in the chord-wise direction.

In a further embodiment of any of the above, the interior region includes a third pedestal group that interconnects the pressure and suction sidewalls.

In a further embodiment of any of the above, the first exit region is provided at the trailing edge.

In a further embodiment of any of the above, the first pedestal group is recessed from the trailing edge or extending to the trailing edge.

In a further embodiment of any of the above, the second exit region is provided at the tip.

In a further embodiment of any of the above, the second pedestal group is recessed from the tip.

In a further embodiment of any of the above, a natural flow direction extends from the interior region to the first exit region. A desired flow direction extends from the interior region to the second exit region. The ends of the second pedestals extend beyond the ends of first pedestals in the desired flow direction.

In a further embodiment of any of the above, the natural flow direction corresponds to an aft direction in the chord-wise direction.

In a further embodiment of any of the above, the desired flow direction corresponds to the radial direction.

In a further embodiment of any of the above, the first and second pedestals include first and second lengths respectively and first and second widths respectively. The first and second lengths are greater than their corresponding first and second widths.

In a further embodiment of any of the above, the first and second pedestals are in an alternating relationship with one another.

In a further embodiment of any of the above, least one first pedestal is arranged between adjacent second pedestals.

In a further embodiment of any of the above, the first length has a ratio relative to the first width of 1<L1/W1<20 and the second length has a ratio relative to the second width of 1<L2/W2<20.

In another exemplary embodiment, a component for a gas turbine engine includes a structure including spaced apart walls that provide an exterior surface that extends in first and second directions to first and second edges, respectively. A cavity is provided between the walls near the first and second edges. The cavity includes an interior region bounded by first and second exit regions and is arranged at angle relative to one another that terminate at the first and second edges arranged at an angle in a range of 60°-120°. The first and second exit regions respectively are in low and high pressure regions relative to one another. First and second pedestal groups respectively are arranged at the first and second exit regions. The second pedestal group has first and second pedestals that each terminate in an end. The ends of the second pedestals extend beyond the ends of first pedestals. The first and second pedestals include first and second lengths respectively and first and second widths respectively. The first and second lengths are greater than their corresponding first and second widths. The first and second pedestals are in an alternating relationship with one another.

In a further embodiment of any of the above, first and second edge are arranged at about 90° relative to one another.

In a further embodiment of any of the above, at least one first pedestals is arranged between adjacent second pedestals.

In a further embodiment of any of the above, the first and second pedestal groups are recessed respectively from the first and second edges.

In a further embodiment of any of the above, the structure is one of a vane, a blade, a blade outer air seal, a combustor liner or an exhaust liner.

In a further embodiment of any of the above, the structure is an airfoil of a blade.

In a further embodiment of any of the above, a natural flow direction extends from the interior region to the first exit region. A desired flow direction extends from the interior region to the second exit region. The ends of the second pedestals extend beyond the ends of first pedestals in the desired flow direction.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 schematically illustrates a high turbine of the gas turbine engine shown in FIG. 1.

FIG. 3A is a perspective view of the airfoil having the disclosed cooling passage.

FIG. 3B is a plan view of the airfoil illustrating directional references.

FIG. 4 is a cross-sectional view of an example airfoil cooling configuration.

FIG. 5A is an enlarged view of an airfoil cooling cavity with pedestals.

FIG. 5B illustrates the flow through the cavity shown in FIG. 5A.

FIG. 6 shows a core used to make the cavity shown in FIGS. 4 and 5A in a partially broken view of the airfoil.

FIG. 7 is an trailing edge view of the core extending from the airfoil.

FIG. 8A is a partially broken airfoil illustrating another example cooling configuration.

FIG. 8B is a cross-sectional view of the airfoil shown in FIG. 8A taken along line 8B-8B.

FIG. 9 shows a core used to make the cavity shown in FIGS. 8A and 8B.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

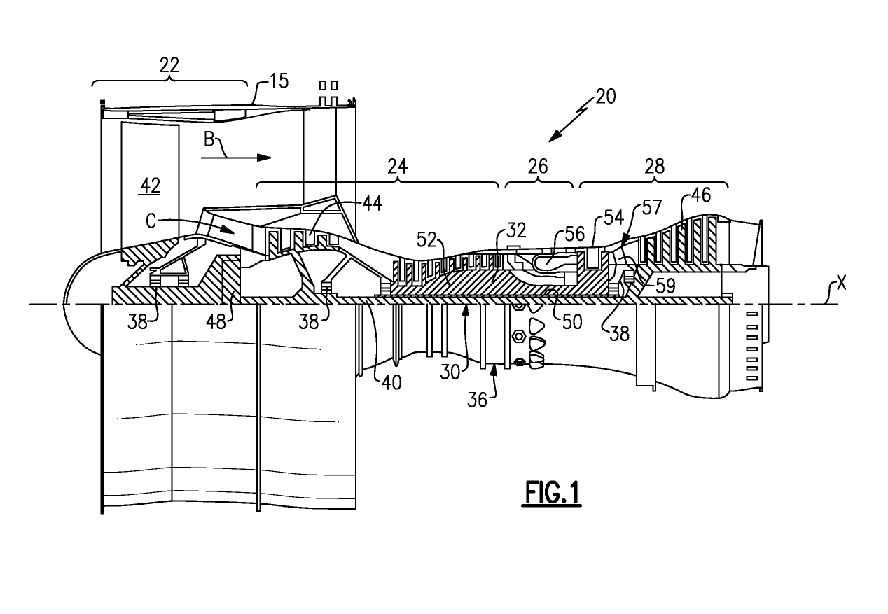

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct at least partially defined within a fan case 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

Moreover, although a commercial gas turbine engine embodiment is illustrated, it should be understood that the disclosed component cooling configuration can be used in other types of engines, such as military and/or industrial engines.

The exemplary engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis X which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7 °R)]^{0.5}. The “Low corrected fan tip speed” as disclosed herein according to one non-limiting embodiment is less than about 1150 ft/second (350.5 meters/second).

The disclosed cooling configuration may be used in various gas turbine engine components. For exemplary purposes, a turbine blade 64 is described. It should be understood that the cooling passage may also be used in vanes, blade outer air seals, and combustor or exhaust liners, for example.

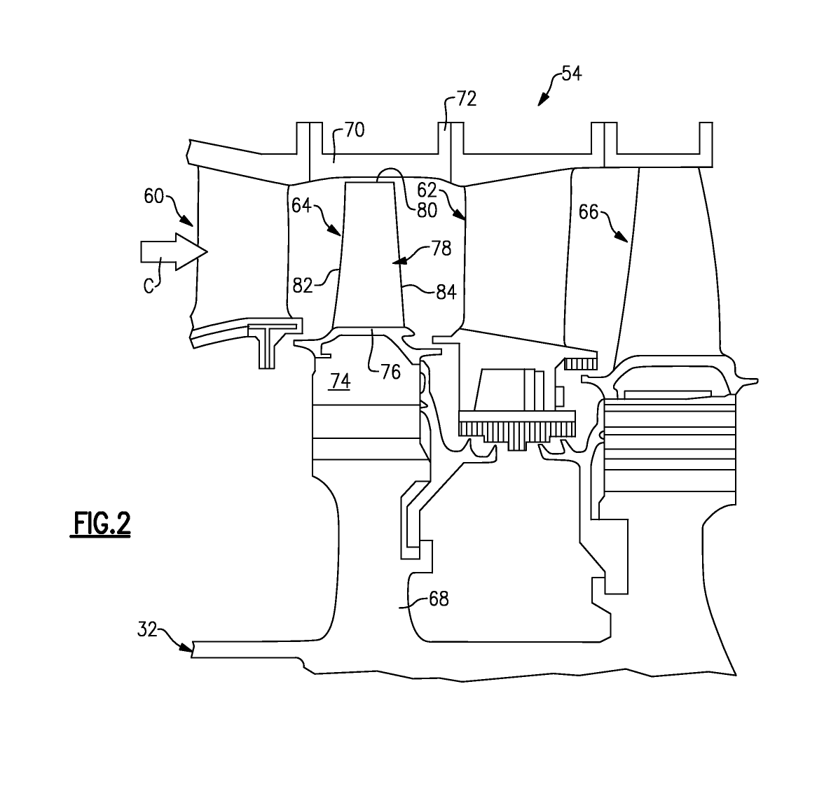

Referring to FIG. 2, a cross-sectional view through a high pressure turbine section 54 is illustrated. In the example high pressure turbine section 54, first and second arrays of circumferentially spaced fixed vanes 60, 62 are axially spaced apart from one another. A first stage array of circumferentially spaced turbine blades 64, mounted to a rotor disk 68, is arranged axially between the first and second fixed vane arrays. A second stage array of circumferentially spaced turbine blades 66 is arranged aft of the second array of fixed vanes 62.

The turbine blades each include a tip 80 adjacent to a blade outer air seal 70 of a case structure 72. The first and second stage arrays of turbine vanes and first and second stage arrays of turbine blades are arranged within a core flow path C and are operatively connected to a spool 32.

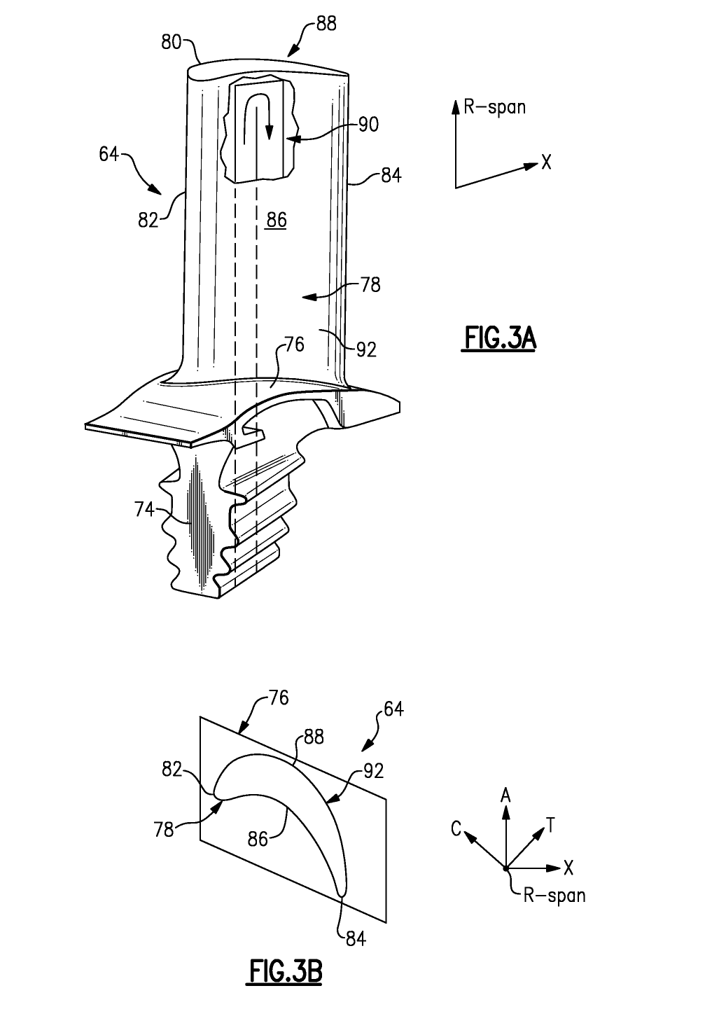

Referring to FIGS. 3A and 3B, a root 74 of each turbine blade 64 is mounted to the rotor disk. The turbine blade 64 includes a platform 76, which provides the inner flow path, supported by the root 74. An airfoil 78 extends in a radial direction R from the platform 76 to the tip 80. It should be understood that the turbine blades may be integrally formed with the rotor such that the roots are eliminated. In such a configuration, the platform is provided by the outer diameter of the rotor. The airfoil 78 provides leading and trailing edges 82, 84.

The airfoil 78 of FIG. 3B somewhat schematically illustrates exterior airfoil surface 92 extending in a chord-wise direction H from a leading edge 82 to a trailing edge 84. The airfoil 78 is provided between pressure (typically concave) and suction (typically convex) side walls 86, 88 spaced apart in an airfoil thickness direction T, which is generally perpendicular to the chord-wise direction C, and joined at the leading and trailing edges 82, 84. Multiple turbine blades 64 are arranged circumferentially in a circumferential direction A. The airfoil 78 extends from the platform 76 in the radial direction R, or spanwise, to the tip 80.

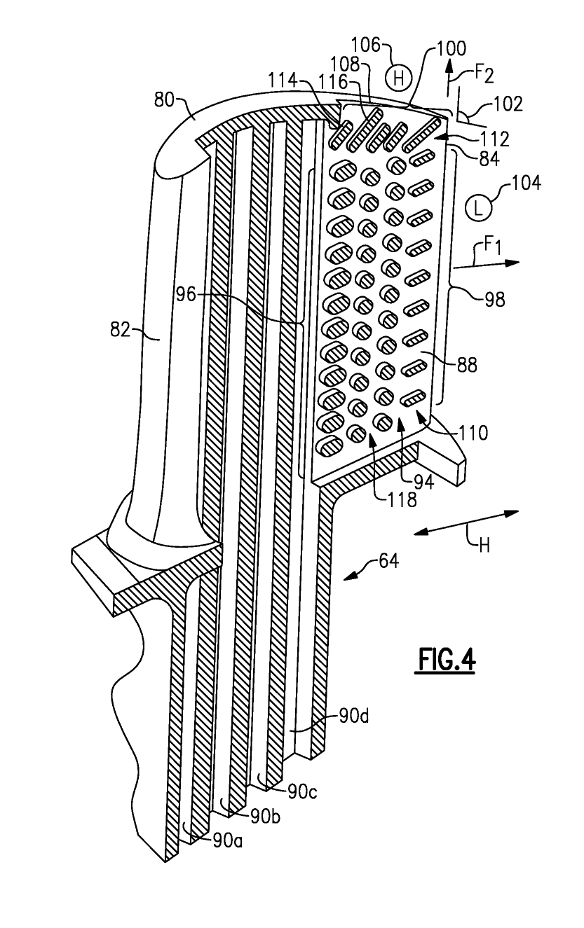

The airfoil 78 includes a cooling passage 90 provided between the pressure and suction walls 86, 88. The cooling passage 90 may be one or more discrete passages arranged in a configuration suitable for the given application. Referring to FIG. 4, the cooling passage 90 is provided by passages 90a-90d. The exterior airfoil surface may include multiple film cooling holes (not shown) in fluid communication with the cooling passage 90.

With continuing reference to FIG. 4, the cooling passage 90d feed a cavity 94 provided between the pressure and suction side walls 86, 88 near the trailing edge 84. In the example, the cavity 94 is provided in at least the last 20% of the airfoil 78 near the trailing edge 84 in the chord-wise direction H.

The cavity 94 includes an interior region 96 bounded by first and second exit regions 98, 100 arranged at angle relative to one another. The first exit region 98 is provided at the trailing edge 84, and the second exit region 100 is provided at a tip edge 108 of the tip 80. Thus, the fluid exit of the cavity 94 runs to the tip 80 to cool this hot corner of the airfoil. The tip 80 and the trailing edge 84 are arranged at an angle 102 in a range of 60°-120°, and in another example, about 90° relative to one another (90°+/−5°).

The first and second exit regions 98, 100 are arranged respectively in low and high pressure regions 104, 106. The high pressure region 106 is at a greater pressure than the low pressure regions 104. A natural flow direction F1 extends from the interior region 96 to the first exit region 98, which corresponds to an aftward direction along the chord-wise direction H in the example blade. The “natural flow direction” is the direction the fluid would tend to flow from the component, here an airfoil, due to the various pressure gradients. A desired flow direction F2 extends from the interior region 96 to the second exit region 100 and generally corresponds to the radial direction R. The “desired flow direction” is a direction that is different than the natural flow direction. That is, the fluid would not flow substantially in the desired flow direction but for the first pedestals 114, discussed below, but would instead tend to flow in the natural flow direction.

Pedestals interconnect the pressure and suction side walls 86, 88. First and second pedestal groups 110, 112 are respectively arranged at the first and second exit regions 98, 100. In the example, the first pedestal group 110 includes a column of pedestals recessed from the trailing edge 84 and elongated in the chord-wise direction H. The first pedestal group 110 may extend all the way to the trailing edge 84, if desired. The second pedestal group 112 is recessed from the tip 80. Recessing the pedestals into the cavity 94 can avoid coat down issues when applying a thermal barrier coating to the exterior airfoil surface.

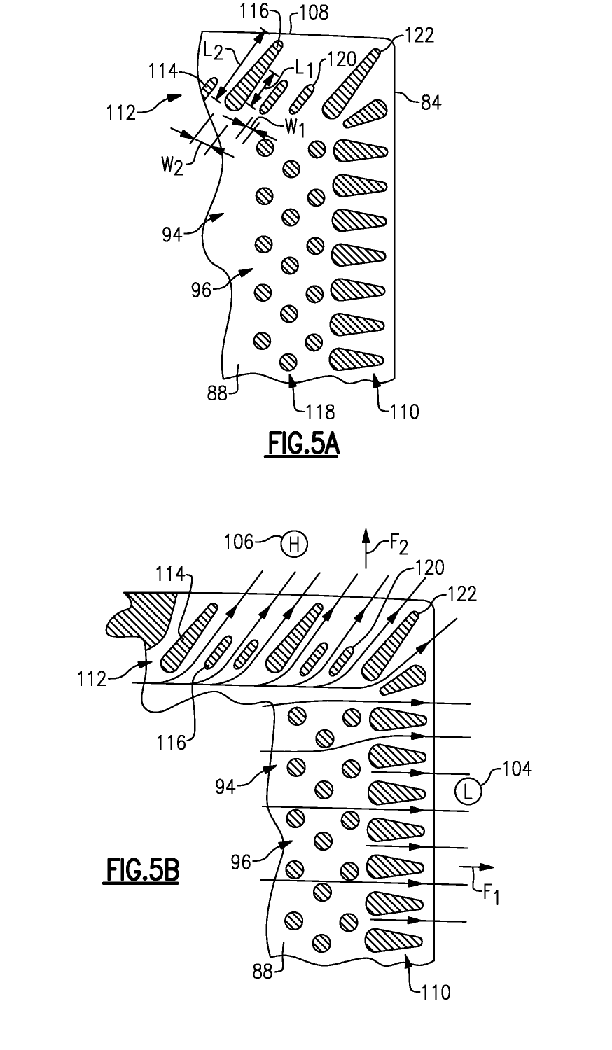

Referring to FIGS. 4, 5A and 5B, the second pedestal group 112 has first and second pedestals 114, 116 each terminating in an end 120, 122. The ends 122 of the second pedestals 116 extend beyond the ends 120 of first pedestals 114 in the desired flow direction F2. In the example, the elongated pedestals of the second pedestal group 112 are arranged an angle of about 30° to 75° relative to the elongated pedestals of the first pedestal group 110. The flow within the cavity 94 will not want to turn and flow out the tip 80. The longer second pedestals 116 prevent flow separation in the second exit region 100, which can result in cooling fluid being forced back into the cavity 94 and out the first exit region 98 due to the higher pressure at the high pressure region 106.

The first and second pedestals 114, 116 include first and second lengths L1, L2 respectively and first and second widths W1, W2 respectively. The first and second lengths L1, L2 are greater than their corresponding first and second widths W1, W2. In one embodiment, 1<L1/W1<20 and 1<L2/W2<20. The first and second pedestals 114, 116 are arranged in alternating relationship with one another. In the example, multiple first pedestals 114 are arranged between adjacent second pedestals 116.

The interior region 96 includes a third pedestal group 118 interconnecting the pressure and suction sidewalls 86, 88 to provide further structural stability and increased cooling to the trailing edge portion of the airfoil.

The longer second pedestals 116 act as “pressure gradient separators” that add to guide the flow through the cavity 94 and out the second exit region 100. Thus, the entire trailing edge tip can be cooled with minimal risk of flow separation and ingestion. By maintaining the continuous slot exit, it is less susceptible to coating deposition. There is internal convection throughout the entire trailing edge tip as well as adequate flow fill in the tip shelf, if one is used. Consequently, tip integrity is maintained and part life is improved. In addition, the blade would retain an improved aerodynamic efficiency over its life cycle.

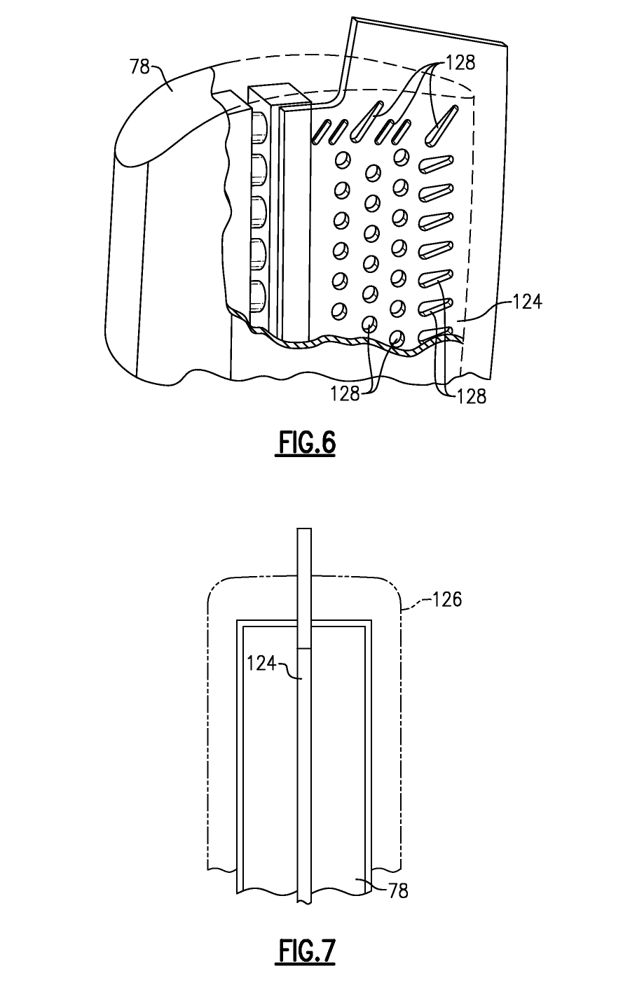

FIGS. 6 and 7 illustrate one approach to forming the pedestals in the cavity. A core 124 having holes 128 corresponding to the pedestal shapes is placed in a mold 126. The core 124 defines the shape of the cavity. The cooling cavity and pedestals can be formed by other manufacturing techniques, such as additive manufacturing, if desired.

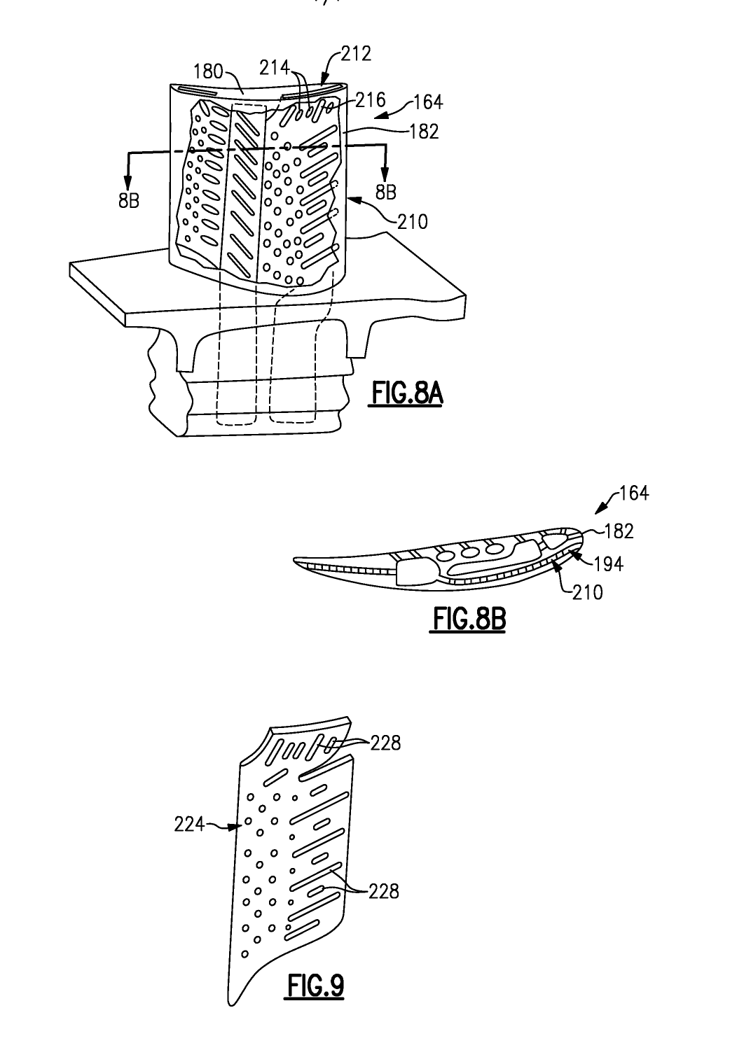

Another embodiment is shown in FIGS. 8A and 8B that illustrate the first and second pedestal groups 210, 212 in a cavity 194 near the leading edge 182 of the airfoil 164. In this example, the first and second pedestals 214, 216 are arranged near the tip 180. FIG. 9 depicts a core 224 having holes 228 corresponding to the pedestal shapes in FIGS. 8A and 8B.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although example embodiments have been disclosed, a worker of ordinary skill in this art would recognize that certain modifications would come within the scope of the claims. For that and other reasons, the following claims should be studied to determine their true scope and content.

What is claimed is:

1. An airfoil for a gas turbine engine comprising:
an airfoil including spaced apart pressure and suction side walls joined at leading and trailing edges to provide an exterior airfoil surface extending in a radial direction from a platform to a tip;
a cavity provided between the pressure and suction side walls near the trailing edge, the cavity includes an interior region bounded by first and second exit regions arranged at angle relative to one another, the first and second exit regions are respectively in low and high pressure regions relative to one another; and
first and second pedestal groups respectively arranged at the first and second exit regions, the second pedestal group has first and second pedestals each terminating in an end, the ends of the second pedestals extend beyond the ends of first pedestals.

2. The airfoil according to claim 1, wherein the airfoil is a blade.

3. The airfoil according to claim 1, wherein the airfoil extends from the leading edge to the trailing edge in a chord-wise direction, the cavity is provided in at least the last 20% of the airfoil near the trailing edge in the chord-wise direction.

4. The airfoil according to claim 3, wherein the interior region includes a third pedestal group interconnecting the pressure and suction sidewalls.

5. The airfoil according to claim 4, wherein the first exit region is provided at the trailing edge.

6. The airfoil according to claim 5, wherein the first pedestal group is recessed from the trailing edge or extending to the trailing edge.

7. The airfoil according to claim 4, wherein the second exit region is provided at the tip.

8. The airfoil according to claim 7, wherein the second pedestal group is recessed from the tip.

9. The airfoil according to claim 1, wherein a natural flow direction extends from the interior region to the first exit region, and a desired flow direction extends from the interior region to the second exit region, and the ends of the second pedestals extend beyond the ends of first pedestals in the desired flow direction.

10. The airfoil according to claim 9, wherein the natural flow direction corresponds to an aft direction in the chord-wise direction.

11. The airfoil according to claim 10, wherein the desired flow direction corresponds to the radial direction.

12. The airfoil according to claim 1, wherein the first and second pedestals include first and second lengths respectively and first and second widths respectively, the first and second lengths greater than their corresponding first and second widths.

13. The airfoil according to claim 12, wherein the first and second pedestals are in alternating relationship with one another.

14. The airfoil according to claim 13, wherein at least one first pedestal is arranged between adjacent second pedestals.

15. The airfoil according to claim 12, wherein the first length has a ratio relative to the first width of 1<L1/W1<20 and the second length has a ratio relative to the second width of 1<L2/W2<20.

16. A component for a gas turbine engine comprising:
a structure including spaced apart walls that provide an exterior surface extending in first and second directions to first and second edges, respectively;
a cavity provided between the walls near the first and second edges, the cavity includes an interior region bounded by first and second exit regions arranged at angle relative to one another that terminate at the first and second edges arranged at an angle in a range of 60°-120°, the first and second exit regions respectively in low and high pressure regions relative to one another;
first and second pedestal groups respectively arranged at the first and second exit regions, the second pedestal group has first and second pedestals each terminating in an end, the ends of the second pedestals extend beyond the ends of first pedestals; and
wherein the first and second pedestals include first and second lengths respectively and first and second widths respectively, the first and second lengths greater than their corresponding first and second widths, wherein the first and second pedestals are in alternating relationship with one another.

17. The component according to claim 16, wherein first and second edge are arranged at about 90° relative to one another.

18. The component according to claim 16, wherein at least one first pedestals is arranged between adjacent second pedestals.

19. The component according to claim 16, wherein the first and second pedestal groups are recessed respectively from the first and second edges.

20. The component according to claim 16, wherein the structure is one of a vane, a blade, a blade outer air seal, a combustor liner or an exhaust liner.

21. The component according to claim 20, wherein the structure is an airfoil of a blade.

22. The component according to claim 16, wherein a natural flow direction extends from the interior region to the first exit region, and a desired flow direction extends from the interior region to the second exit region, and the ends of the second pedestals extend beyond the ends of first pedestals in the desired flow direction.
